(19) United States
(12) Patent Application Publication
(10) Pub. No.: US 2019/0088974 A1
(43) Pub. Date: Mar. 21, 2019

(54) METHOD FOR COMPRESSING A SOLID OXIDE FUEL CELL STACK

(71) Applicant: PHILLIPS 66 COMPANY, Houston, TX (US)

(72) Inventors: Mark Jensen, Bartlesville, OK (US); Ying Liu, Bartlesville, OK (US)

(73) Assignee: PHILLIPS 66 COMPANY, Houston, TX (US)

(21) Appl. No.: 16/135,546

(22) Filed: Sep. 19, 2018

Related U.S. Application Data
(60) Provisional application No. 62/560,366, filed on Sep. 19, 2017.

(51) Int. Cl. H01M 8/248; H01M 8/12

(52) U.S. Cl. CPC H01M 8/248; H01M 2008/1293; H01M 8/12

(57) ABSTRACT

A fuel cell stack is in contact and below a top compression plate and in contact and above a bottom compression plate. The top compression plate and the bottom compression plate are flat and rigid. A top compression device is above the top compression plate, wherein the top compression device applies a downward vertical force onto the top compression plate which applies a downward vertical force onto the fuel cell stack. An optional bottom compression device is below the bottom compression plate, wherein the bottom compression device applies an upward vertical force onto the bottom compression plate which applies an upward vertical force onto the fuel cell stack.

### CROSS-REFERENCE TO RELATED APPLICATIONS

This application is a non-provisional application which claims the benefit of and priority to U.S. Provisional Application Ser. No. 62/560,366 filed Sep. 19, 2017, entitled “Method for Compressing a Solid Oxide Fuel Cell Stack,” which is hereby incorporated by reference in its entirety.

### STATEMENT REGARDING FEDERALLY SPONSORED RESEARCH OR DEVELOPMENT

None.

### FIELD OF THE INVENTION

This invention relates to a method for compressing a solid oxide fuel cell stack.

### BACKGROUND OF THE INVENTION

A solid oxide fuel cell (SOFC) stack can be subjected to various interruptions that can prevent or reduce electricity from being generated. One of those interruptions can be cell(s) cracking, which is usually a result of the stack pressure in a SOFC system exceeding the strength of the SOFC cells. Another interruption that can occur is the leaking of gases through compressive seals.

In conventional SOFC stack designs based on simple mechanics such as springs, pressure will increase or decrease with temperature-caused expansion or contraction during SOFC startup and operation due to a linear correlation between spring force and spring displacement. At some point, the stress placed on the cells may exceed the cell strength resulting in cell cracking and thus stack failure. On the other hand, pressure decrease may cause leaking of gases through compressive seals. There exists a need for an SOFC stack design that is able to handle the expansion and contraction due to the temperature change and maintain a constant pressure during SOFC operation.

### BRIEF SUMMARY OF THE DISCLOSURE

A fuel cell stack that is in contact and below a top compression plate and in contact and above a bottom compression plate, wherein the top compression plate and the bottom compression plates are flat and rigid. A top compression device is above the top compression plate, wherein the top compression device applies a downward vertical force onto the top compression plate which applies a downward vertical force onto the fuel cell stack. An optional bottom compression device is below the bottom compression plate, wherein the bottom compression device applies an upward vertical force onto the bottom compression plate which applies an upward vertical force onto the fuel cell stack.

A fuel cell stack is in contact and below a top compression plate and in contact and above a bottom compression plate, wherein the top compression plate and the bottom compression plate are flat and rigid. In this fuel cell stack, a top compression rod is in contact and above the top compression plate, wherein the top compression rod applies a downward vertical force onto the top compression plate which applies a downward vertical force onto the fuel cell stack. Additionally, in this fuel cell stack, a bottom compression rod is in contact and below the bottom compression plate, wherein the bottom compression rod applies an upward vertical force onto the bottom compression plate which applies an upward vertical force onto the fuel cell stack. In this fuel cell stack there is also at least one alignment rod extending through at least one alignment hole in the top compression plate and extending through at least one alignment hole in the bottom compression plate, wherein the alignment rod does not apply any vertical compressive force onto the fuel cell stack. Additionally, in this fuel cell stack, the top compression plate and the bottom compression plate are enclosed within an insulated compartment and the top compression rod and the bottom compression rod extend outside the insulated compartment.

A fuel cell stack that is in contact and below a top compression plate and in contact and above a bottom compression plate, wherein the top compression plate and the bottom compression plate are flat and rigid. In this fuel cell stack a top compression cable is in contact and above the top compression plate, wherein the top compression cable applies a downward vertical force onto the top compression plate which applies a downward vertical force onto the fuel cell stack. Additionally, in this fuel cell stack a bottom compression cable is in contact and below the bottom compression plate, wherein the bottom compression cable applies an upward vertical force onto the bottom compression plate which applies an upward vertical force onto the fuel cell stack. In this fuel cell stack there is also at least one alignment rod extending through at least one alignment hole in the top compression plate and extending through at least one alignment hole in the bottom compression plate, wherein the alignment rod does not apply any vertical compressive force onto the fuel cell stack. Additionally, in this fuel cell stack, the fuel cell stack, top compression plate, bottom compression plate, part of the top compression cable and part of the bottom compression cable are enclosed inside an insulated compartment. Furthermore, the top compression cable and the bottom compression cable extend outside the insulated compartment and are connected to a pulley system, outside the insulated compartment, capable of pulling both the top compression cable and the bottom compression cable simultaneously.

### BRIEF DESCRIPTION OF THE DRAWINGS

A more complete understanding of the present invention and benefits thereof may be acquired by referring to the following description taken in conjunction with the accompanying drawings in which:

FIG. 1 depicts a front cross-sectional view of a SOFC stack design.

FIG. 2 depicts an overhead sectional view of a SOFC stack design.

FIG. 3 depicts an overhead sectional view of a SOFC stack design.

FIG. 4 depicts the SOFC stack design with compression rods.

FIG. 5 depicts the SOFC stack design with compression cables.

FIG. 6 depicts the SOFC stack design within a frame.

FIG. 7 depicts a comparison of electrochemical performance between a SOFC stack compressed by the conventional method versus an embodiment of the novel SOFC stack compression method.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

The following examples of certain embodiments of the invention are given. Each example is provided by way of explanation of the invention, one of many embodiments of the invention, and the following examples should not be read to limit, or define, the scope of the invention.

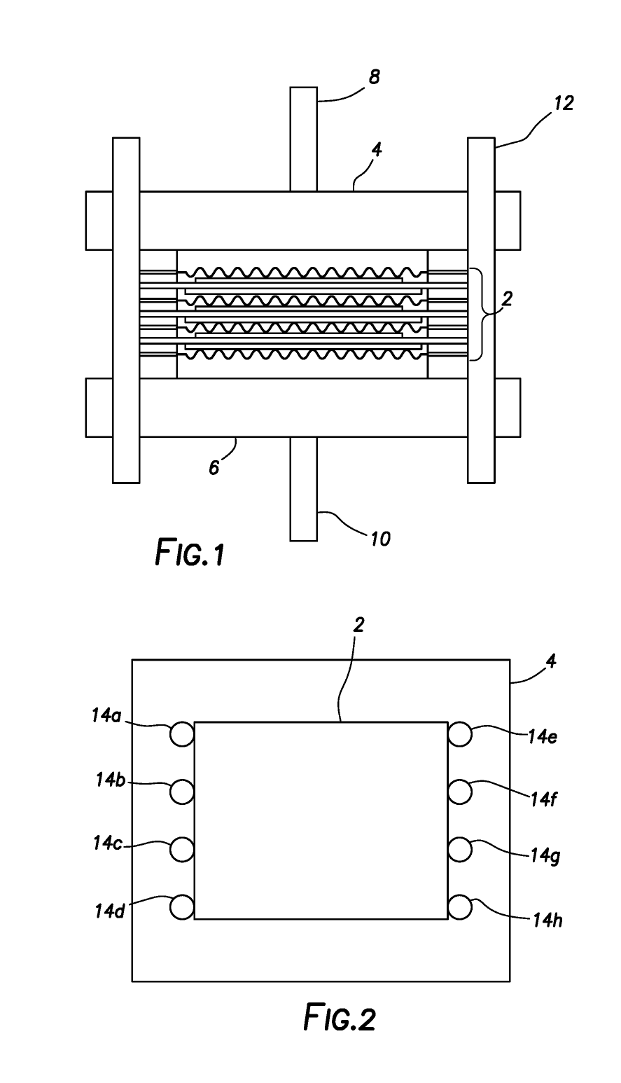

FIG. 1 is a front cross-sectional view of one embodiment of the SOFC stack design. As shown in FIG. 1, the SOFC stack design can comprise a fuel cell stack (2) that is in contact and below a top compression plate (4) and above a bottom compression plate (6). The top compression plate and the bottom compression plate are flat and rigid. A top device (8) is above the top compression plate, wherein the top device applies a downward vertical force onto the top compression plate which applies a downward vertical force onto the fuel cell stack. An optional bottom device (10) in contact and below the bottom compression plate, wherein the bottom device applies an upward vertical force onto the bottom compression plate which applies an upward vertical force onto the fuel cell stack. In embodiments in which the optional bottom compression device is not used it is envisioned that the bottom compression plate will be resting on a solid unmovable base and the only compression of the fuel cell stack will come from the top compression plate. In one embodiment, an alignment rod (12) can extend through at least one alignment hole (not shown) in the top compression plate and extend through at least one alignment hole in the bottom compression plate, wherein the alignment device does not apply any vertical compressive force onto the fuel cell stack.

It is envisioned that this configuration will allow for constant pressure on the fuel cell stack despite dimensional changes in the stacking direction.

In one embodiment the top device is a top compression rod and the bottom device is a bottom compression rod. In an alternate embodiment, the top device is a top compression cable and the bottom device is a bottom compression cable.

FIG. 2 depicts an overhead sectional view of the SOFC stack design. In this overhead view there are eight alignment holes (14a, 14b, 14c, 14d, 14e, 14f, 14g, and 14h) in the top compression plate (4). The number of holes for the alignment rods can range from one to one thousand and can be influenced by the size of the fuel cell stack (2). Different arrangements for the alignment holes can depend on the size of the fuel cell stack. In some embodiments it can be envisioned that one hole is sufficient to ensure that the top compression plate and the bottom compression plate do not move perpendicular to the top compression device and the SOFC stack. In other embodiments it is envisioned that two alignment holes are needed or even, three, four, five, six, seven, eight, nine, ten, twenty, twenty-five or even thirty.

As depicted in this embodiment of FIG. 2, the alignment holes are situated on the left side and the right side of the fuel cell stack. It is envisioned that the alignment holes can be situated in any known arrangement necessary to ensure proper alignment of the top compression plate with the bottom compression plate. Additionally, the alignment holes can be situated in any known arrangement necessary to ensure proper alignment of either or both compression plate(s) with the SOFC stack.

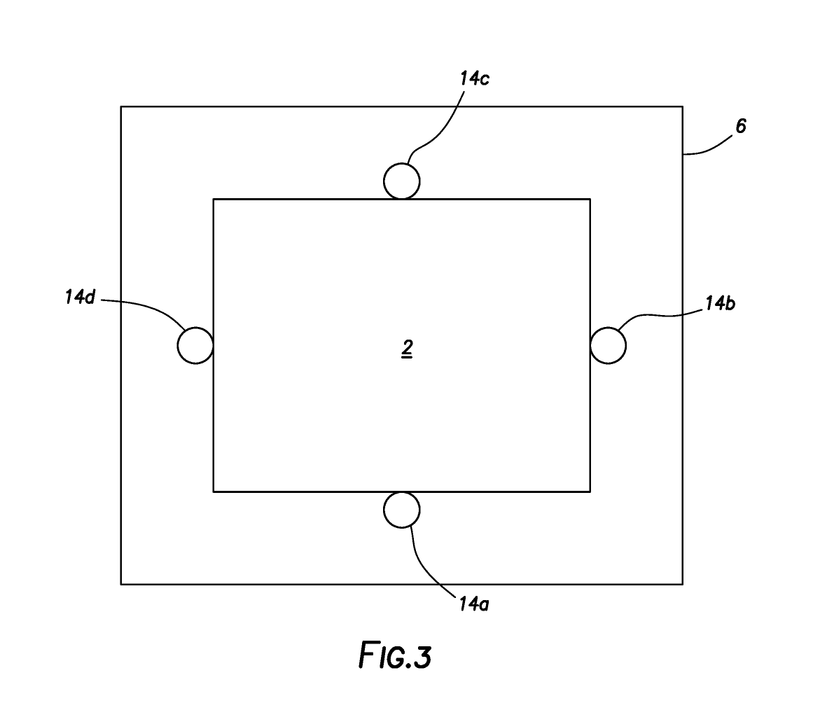

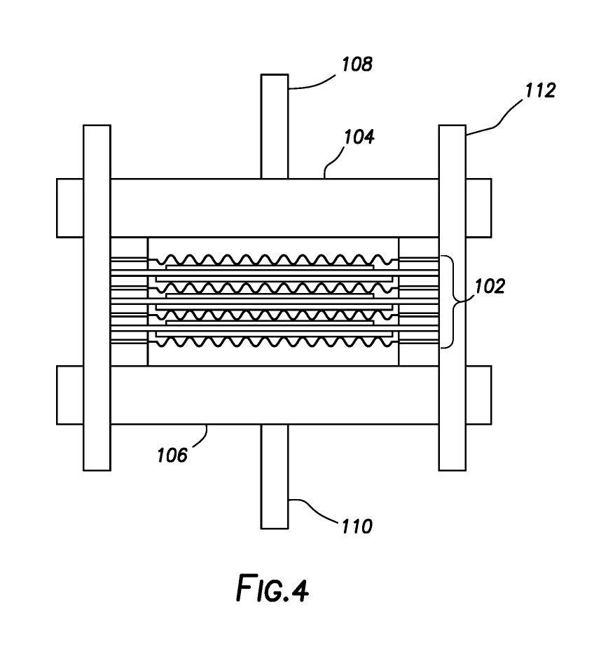

One way to ensure proper alignment of the compression plate(s) with the SOFC stack is to have the alignment holes in a position wherein they are in contact with the fuel cell stack to prevent it from moving; this possibility is shown in FIG. 3. In this embodiment, a top down view of the fuel cell stack (2) and the bottom compression plate (6) are shown where the alignment holes (14a, 14b, 14c and 14d) are right next to the fuel cell stack. In this embodiment, any alignment rods placed within the alignment holes will be in contact with the fuel cell stack to prevent movement. In another embodiment it is possible that the alignment holes are spaced away from the fuel cell stack that they are not touching the fuel cell stack.

FIG. 4 is a front cross-sectional view of one embodiment of the SOFC stack design wherein the top device and the bottom device are a top compression rod and a bottom compression rod, respectfully. As shown in FIG. 4, the SOFC stack design can comprise a fuel cell stack (102) that is in contact and below a top compression plate (104) and above a bottom compression plate (106). The top compression plate and the bottom compression plate are flat and rigid. A top compression rod (108) is above the top compression plate, wherein the top compression rod applies a downward vertical force onto the top compression plate which applies a downward vertical force onto the fuel cell stack. An optional bottom compression rod (110) in contact and below the bottom compression plate, wherein the bottom compression rod applies an upward vertical force onto the bottom compression plate which applies an upward vertical force onto the fuel cell stack. In embodiments in which the optional bottom compression rod is not used it is envisioned that the bottom compression plate will be resting on a solid unmovable base and the only compression of the fuel cell stack will come from the top compression plate. In one embodiment, an alignment rod (112) can extend through at least one alignment hole (not shown) in the top compression plate and extending through at least one alignment hole in the bottom compression plate, wherein the alignment rod does not apply any vertical compressive force onto the fuel cell stack.

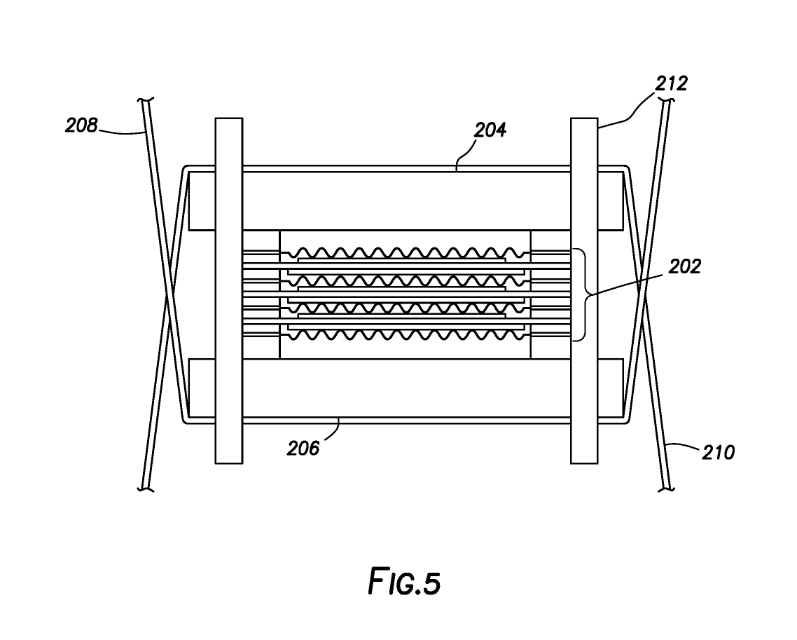

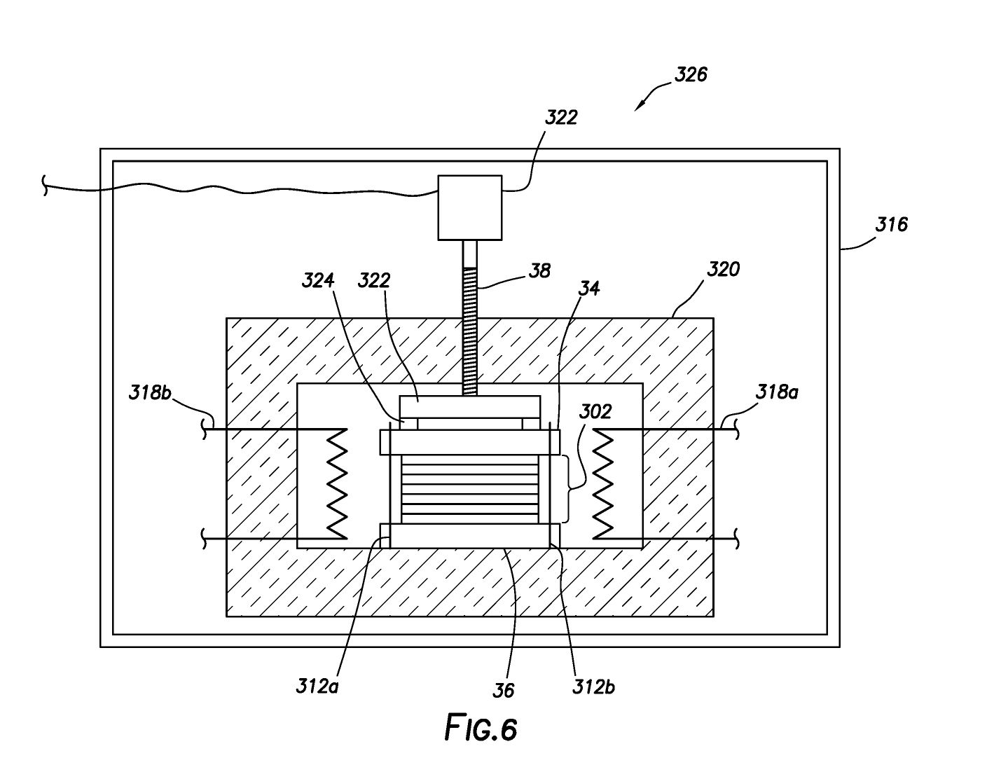

FIG. 5 is a front cross-sectional view of one embodiment of the SOFC stack design wherein the top device and the bottom device are a top compression cable and a bottom compression cable, respectfully. As shown in FIG. 5, the SOFC stack design can comprise a fuel cell stack (202) that is in contact and below a top compression plate (204) and above a bottom compression plate (206). The top compression plate and the bottom compression plate are flat and rigid. A top compression cable (210) is above the top compression plate and extends below the fuel cell stack, wherein the top compression cable applies a downward vertical force onto the top compression plate which applies a downward vertical force onto the fuel cell stack. An optional bottom compression cable (208) is in contact and below the bottom compression plate and extends above the fuel cell stack, wherein the bottom compression cable applies an upward vertical force onto the bottom compression plate which applies an upward vertical force onto the fuel cell stack. In embodiments in which the optional bottom compression cable is not used it is envisioned that the bottom compression plate will be resting on a solid unmovable base and the only compression of the fuel cell stack will come from the top compression plate. In an alternative embodiment in which the optional bottom compression cable is not used it is envisioned that the bottom compression plate can be attached to a bottom compression rod to apply an upward vertical force on the fuel cell stack. At least one alignment rod (212) extending through at least one alignment hole (not shown) in the top compression plate and extending through at least one alignment hole in the bottom compression plate, wherein the alignment rod does not apply any vertical compressive force onto the fuel cell stack.

In one embodiment not shown, the SOFC stack design can be used with a top compression cable and a bottom compression rod. Alternatively, the SOFC stack design can be used with a top compression rod and a bottom compression cable.

When the SOFC stack design is used with a top compression cable as a top device and/or a bottom compression cable as a bottom device, the top compression cable and/or the bottom compression cable can be made of stainless steel. In some embodiments, there can be two, three, four or even more top compression cables and/or bottom compression cables. In some embodiments, the top compression cable can be connected to a top pulley system to increase tension on the top compression cable thereby imparting a downward vertical force onto the fuel cell stack. In other embodiments, the bottom compression cable can be connected to a bottom pulley system to increase tension on the bottom compression cable thereby imparting an upward vertical force onto the fuel cell stack. In yet another embodiment, both the top compression cable and the bottom compression cable can be connected to a singular pulley system capable of pulling both the top compression cable and the bottom compression cable simultaneously.

FIG. 6, depicts the novel SOFC stack compression system with a top compression rod within a frame (316). In this embodiment the optional bottom compression rod is removed. An insulating structure (320) is placed within the frame that may have at least one heating element placed within. In FIG. 6, it is depicted that two heating elements (318a and 318b) are placed within the insulating structure. In other embodiments not currently shown, heating elements may not be necessary in an SOFC stack design. In the embodiment of FIG. 6, the bottom compression plate (306) rests on the insulating structure. A fuel cell stack (302) is compressed between the bottom compression plate and the top compression plate (304). Two alignment rods (312a and 312b) are shown aligning the top compression plate and the bottom compression plate. The top compression rod (308) is connected to a distribution plate (322) that is in contact with spacers (324) capable of exerting pressure onto the top compression plate (304). Devices that can be used as either the top compression device or the bottom compression device include pneumatic and hydraulic cylinders (326).

As shown in FIG. 6, the top compression device is placed outside the insulating structure to ensure that the top compression device is not subject to the extreme temperatures required by the fuel cell stack during operation. It is envisioned that this pressure for the top compression device and the optional bottom compression device is controlled to ensure that a proper seal for the fuel cell stack is maintained and that the strength of the fuel cell stack is not exceeded. It is also envisioned that the pressure for the top compression device or the optional bottom compression device will not vary with time as thermal expansion/contraction or different forms of degradation may change the fuel cell stack dimensions.

In an alternate embodiment a novel SOFC stack compression method can be done with a top compression cable and/or bottom compression cable similarly to FIG. 6. In this embodiment, the pulley can be either inside or outside the insulating structure

In some embodiments it is envisioned that the amount of pressure needed to seal the fuel cell stack without destroying the fuel cell stack will range from about 2 psi to 1,500 psi. This pressure is the pressure measured on the fuel cell stack and individual stack components such as seals may have a higher effective pressure due to reduced areas for transmitting the pressure in the stacking direction. In other embodiments the pressure can range from about 80 psi to 1,000 psi, or 5 psi to 200 psi, or 2 psi to 15 psi.

In one embodiment, a top pressure distribution plate and an optional bottom pressure distribution plate are used to ensure even distribution of the pressure from the top compression rod and optional bottom compression rod. Minimizing the deflection of the compression plates by adding the pressure distribution plates more evenly exerts pressure on the SOFC stack between the top compression plate and the bottom compression plate. While it is envisioned that the top compression plate and the bottom compression plate can be made of material that is partially inert to the extreme pressures and temperatures within the insulation box these materials are often subject to deflection and creep. Materials that the top compression plate and the bottom compression plate can be made from include ceramics, titanium, Inconel alloys, stainless steels and other materials with softening temperatures greater than the SOFC stack operating temperature. In this embodiment a top pressure distribution plate and an optional bottom pressure distribution plate can be made from the same materials as the top compression plate and the bottom compression plate.

In one embodiment, the compression rods are made of the same materials as the top and bottom compression plates.

In another optional method, spacers can be placed between the top pressure distribution plate and the top compression plate as well as spacers being placed between the optional bottom pressure distribution plate and the bottom compression plate to aid in minimizing the deflection at the furthermost edges of the SOFC stack. The primary transmission of SOFC stack pressure occurs in the seals and the maximum deflection during compression is found at the furthermost edges of the SOFC stack.

In one embodiment, electrolyte materials for the SOFCs can be any conventionally known electrolyte materials. One example of electrolyte materials can include doped zirconia electrolyte materials, doped ceria materials or doped lanthanum gallate materials. Examples of dopants for the doped zirconia electrolyte materials can include: CaO, MgO, Y₂O₃, Sc₂O₃, Sm₂O₃ and Yb₂O₃. In one embodiment the electrolyte material is an yttria-stabilized zirconia, (ZrO₂)_{0.92}(Y₂O₃)_{0.08}.

In one embodiment, anode materials for the SOFCs can be any conventionally known anode materials. Examples of the anode materials can include mixtures of NiO, yttria-stabilized zirconia, gadolinium doped ceria, CuO, CoO and FeO. In one embodiment the anode material is a mixture of 50 wt % NiO and 50 wt % yttria-stabilized zirconia.

In one embodiment, cathode materials for the SOFC can be any conventionally known cathode materials. One example of cathode materials can be perovskite-type oxides with the general formula ABO₃, wherein A cations can be La, Sr, Ca, Pb, etc. and B cations can be Ti, Cr, Ni, Fe, Co, Zr, etc. Other examples of cathode materials can be mixtures of lanthanum strontium cobalt ferrite, lanthanum strontium manganite, yttria-stabilized zirconia or gadolinium doped ceria. Examples of the cathode materials include: Pr_{0.5}Sr_{0.5}FeO_{3-δ}; Sr_{0.9}Ce_{0.1}Fe_{0.8}Ni_{0.2}O_{3-δ}; Sr_{0.8}Ce_{0.1}Fe_{0.7}Co_{0.3}O_{3-δ}; LaNi_{0.6}Fe_{0.4}O_{3-δ}; Pr_{0.8}Sr_{0.2}Co_{0.2}Fe_{0.8}O_{3-δ}; Pr_{0.7}Sr_{0.3}Co_{0.2}Mn_{0.8}O_{3-δ}; Pr_{0.8}Sr_{0.2}FeO_{3-δ}; Pr_{0.6}Sr_{0.4}Co_{0.8}Fe_{0.2}O_{3-δ}; Pr_{0.4}Sr_{0.6}Co_{0.8}Fe_{0.2}O_{3-δ}; Pr_{0.7}Sr_{0.3}Co_{0.9}Cu_{0.1}O_{3-δ}; Ba_{0.5}Sr_{0.5}Co_{0.8}Fe_{0.2}O_{3-δ}; Sm_{0.5}Sr_{0.5}CoO_{3-δ}; and LaNi_{0.6}Fe_{0.4}O_{3-δ}. In one embodiment the cathode material is a mixture of gadolinium-doped ceria (Ce_{0.9}Gd_{0.1}O₂) and lanthanum strontium cobalt ferrite (La_{0.6}Sr_{0.4}Co_{0.2}Fe_{0.8}O₃) or a mixture of gadolinium-doped ceria (Ce_{0.9}Gd_{0.1}O₂) and samarium strontium cobaltite (Sm_{0.5}Sr_{0.5}CoO₃).

### EXAMPLE 1

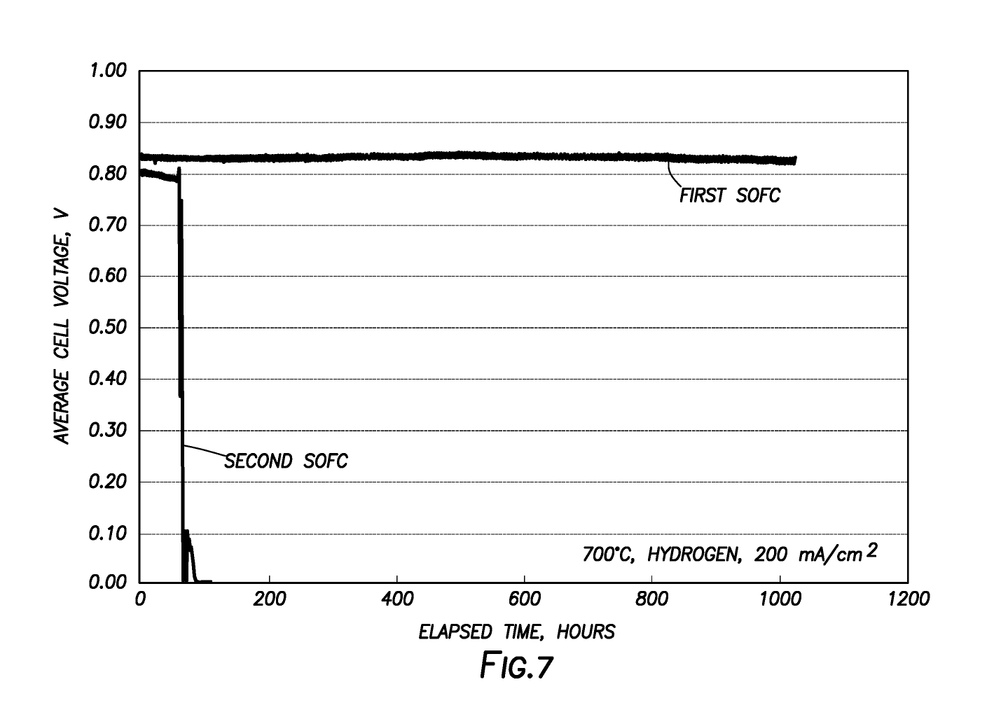

In this example two different solid oxide fuel cell short stacks were created. Each SOFC stack comprised two fuel cells. Each fuel cell of both the first solid oxide fuel cell stack and the second solid oxide fuel cell stack had an anode comprising 50 wt. % Ni-50 wt. % (ZrO₂)_{0.92}(Y₂O₃)_{0.08}, a cathode comprising 50 wt. % La_{0.6}Sr_{0.4}Co_{0.2}Fe_{0.8}O₃-50 wt. % Ce_{0.9}Gd_{0.1}O₂ and an electrolyte comprising (ZrO₂)_{0.92}(Y₂O₃)_{0.08}. Both the first solid oxide fuel cell short stack and the second solid oxide fuel cell short stack were operated at 700° C. on hydrogen fuel with a current density of 200 mA/cm². However, the first solid oxide fuel cell stack had a constant pressure of 30 psi exerted upon it while the second solid oxide fuel cell stack was held together using 6 steel bolts at the edges to achieve an effective pressure of 30 psi at ambient temperature. As shown in FIG. 7, the first solid oxide fuel cell stack could sustain an average cell voltage greater than 0.8 V for over 1000 hours while the second solid oxide fuel cell stack showed a high degradation rate and was only able to sustain its operating voltage for less than 50 hours.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A system comprising:
a fuel cell stack in contact and below a top compression plate and in contact and above a bottom compression plate, wherein the top compression plate and the bottom compression plate are flat and rigid;
a top device above the top compression plate, wherein the top device applies a downward vertical force onto the top compression plate which applies a downward vertical force onto the fuel cell stack; and
an optional bottom device below the bottom compression plate, wherein the bottom device applies an upward vertical force onto the bottom compression plate which applies an upward vertical force onto the fuel cell stack.

2. The system of claim 1, wherein the top compression plate and the bottom compression plate apply a constant compression onto the fuel cell stack.

3. The system of claim 1, wherein the top device applies a downward vertical force onto the fuel cell stack independent of the conditions within the fuel cell stack.

4. The system of claim 1, wherein the optional bottom device applies an upward vertical force onto the fuel cell stack independent of the conditions with the fuel cell stack.

5. The system of claim 1, wherein the downward vertical force applied by the top device creates a SOFC stack pressure in the range of about 2 psi to about 1,500 psi.

6. The system of claim 1, wherein the upward vertical force applied by the bottom device creates a SOFC stack pressure in the range of about 2 psi to about 1,500 psi.

7. The system of claim 1, wherein the downward vertical force applied by the top compression plate is evenly distributed onto the fuel cell stack.

8. The system of claim 1, wherein the upward vertical force applied by the bottom compression plate is evenly distributed onto the fuel cell stack.

9. The system of claim 1, wherein the operating temperature of the fuel cell stack ranges from 500° C. to about 900° C.

10. The system of claim 1, wherein the top device is connected to a top pressure distribution plate that distributes pressure evenly onto the top compression plate.

11. The system of claim 1, wherein the optional bottom device is connected to an optional bottom pressure distribution plate that distributes pressure evenly onto the bottom compression plate.

12. The system of claim 1, wherein the system comprises at least one alignment rod extending through at least one alignment hole in the top compression plate and extending through at least one alignment hole in the bottom compression plate, wherein the alignment rod does not apply any vertical compressive force onto the fuel cell stack.

13. The system of claim 12, wherein the alignment rod is unthreaded.

14. The system of claim 1, wherein the top device is a top compression rod and the bottom device is a bottom compression rod.

15. The system of claim 14, wherein the compression rods are made of stainless steel.

16. The system of claim 14, wherein the top compression rod and the optional bottom compression rod are connected to a pneumatic or hydraulic piston.

17. The system of claim 14, wherein the top compression rod and the optional bottom compression rod are non-metallic.

18. The system of claim 14, wherein the top compression rod and the optional bottom compression rod are ceramic.

19. The system of claim 1, wherein the top device is a top compression cable and the bottom device is a bottom compression cable.

20. The system of claim 19, wherein the top compression cable and the bottom compression cable are stainless steel.

21. The system of claim 19, wherein the top compression cable is connected to a top pulley system.

22. The system of claim 19, wherein the bottom compression cable is connected to a bottom pulley system.

23. The system of claim 19, wherein both the top compression cable and the bottom compression cable are connected to a pulley system capable of pulling both the top compression cable and the bottom compression cable simultaneously.

24. A system comprising:
a fuel cell stack in contact and below a top compression plate and in contact and above a bottom compression plate, wherein the top compression plate and the bottom compression plate are flat and rigid;
a top compression rod in contact and above the top compression plate, wherein the top compression rod applies a downward vertical force onto the top compression plate which applies a downward vertical force onto the fuel cell stack;
a bottom compression rod in contact and below the bottom compression plate, wherein the bottom compression rod applies an upward vertical force onto the bottom compression plate which applies an upward vertical force onto the fuel cell stack; and
at least one alignment rod extending through at least one alignment hole in the top compression plate and extending through at least one alignment hole in the bottom compression plate, wherein the alignment rod does not apply any vertical compressive force onto the fuel cell stack,
wherein the fuel cell stack, the top compression plate and the bottom compression plate are enclosed within an insulated compartment and the top compression rod and the bottom compression rod extend outside the insulated compartment.

25. The system of claim 24, wherein the force exerted by the top compression rod and the bottom compression rod are applied outside the insulated compartment.

26. A system comprising:
a fuel cell stack in contact and below a top compression plate and in contact and above a bottom compression plate, wherein the top compression plate and the bottom compression plate are flat and rigid;
a top compression cable in contact above the top compression plate, wherein the top compression cable applies a downward vertical force onto the top compression plate which applies a downward vertical force onto the fuel cell stack;
an optional bottom compression cable in contact below the bottom compression plate, wherein the bottom compression cable applies an upward vertical force onto the bottom compression plate which applies an upward vertical force onto the fuel cell stack; and
at least one alignment rod extending through at least one alignment hole in the top compression plate and extending through at least one alignment hole in the bottom compression plate, wherein the alignment rod does not apply any vertical compressive force onto the fuel cell stack,
wherein the fuel cell stack, top compression plate, bottom compression plate, part of the top compression cable and part of the bottom compression cable are enclosed inside an insulated compartment and wherein the top compression cable and the bottom compression cable extend outside the insulated compartment and are connected to a pulley system, outside the insulated compartment, capable of pulling both the top compression cable and the bottom compression cable simultaneously.
